(19) United States
(12) Patent Application Publication
(10) Pub. No.: US 2026/0316497 A1
(43) Pub. Date: Oct. 15, 2026

(54) TIRE AND POWER FEED SYSTEM

(71) Applicant: THE YOKOHAMA RUBBER CO., LTD., Kanagawa (JP)

(72) Inventors: Atsushi TANNO, Kanagawa (JP); Hirokazu SUZUKI, Tokyo (JP)

(21) Appl. No.: 18/880,761

(22) PCT Filed: Jul. 5, 2023
(86) PCT No.: PCT/JP2023/024861

§ 371 Date: Jan. 2, 2025

(30) Foreign Application Priority Data
Jul. 7, 2022 (JP) 2022-109677

(51) Int. Cl. B60C 23/04

(52) U.S. Cl. CPC B60C 23/0413

(57) ABSTRACT

A tire includes a power reception coil receiving an AC magnetic field from outside the tire to generate power. The power reception coil is provided on a side inner surface of a side portion between a tread portion and a bead portion. The side inner surface faces a tire cavity region of the tire. The power reception coil generates AC power by receiving an AC magnetic field transmitted through the side portion. The power reception coil is a coil having a circular shape and extending to make one round in a tire circumferential direction along the side inner surface. A ratio Ts/Tmin is from 1.0 to 5.5, where Ts is a thickness of the side portion at a position of the side inner surface where the power reception coil is provided, and Tmin is a minimum thickness among thicknesses of the side portion extending in a tire radial direction.

### TECHNICAL FIELD

The present technology relates to a tire and a power feed system that feeds power to an electronic device provided in the tire.

### BACKGROUND ART

Technology for incorporating an electronic device such as a sensor in a tire and monitoring a state of the tire has been proposed. For example, to monitor air pressure of a pneumatic tire, there is an internal pressure warning system in which a pressure sensor and a transmission device are provided in a tire cavity region, and monitoring results of pressure obtained by the pressure sensor are wirelessly transmitted from the transmission device to a reception device on a vehicle side, and a tire deformation behavior measurement system in which an acceleration sensor is provided on an inner circumferential surface side of a tread portion in a tire cavity region, and monitoring results of deformation behavior of the tread portion during rolling of a tire, which are obtained by the acceleration sensor, are wirelessly transmitted from a transmission device provided in the tire cavity region to a reception device on a vehicle side.

Power is required to drive such a sensor and a transmission device, and the power is fed, for example, from a battery built in the transmission device. However, since the capacity of the power fed by the battery is limited, the sensor and the transmission device cannot be driven semipermanently, and complicated processing of disassembling a pneumatic tire mounted on a wheel from the wheel and replacing an exhausted battery in a tire cavity region is required.

In contrast, technology for providing a tire that includes a built-in electric circuit and that can stably feed power to the electric circuit, and a power feed structure to the tire is known (Japan Unexamined Patent Publication No. 2000-255229 A).

In the above-described technology, the electric circuit that receives power to be driven, and a secondary coil connected to the electric circuit are provided in the tire for an automobile, and an inverter connected to a power supply of a vehicle, and a primary coil that is disposed in a portion opposing the tire of a vehicle main body, and that is energized by the inverter are provided in the vehicle main body of the automobile.

In the above-described technology, a plurality of the secondary coils provided in the tire cavity region are embedded adjacent to each other in an entire periphery of an inner circumferential surface of a sidewall of the tire (FIG. 5 of Japan Unexamined Patent Publication No. 2000-255229 A).

In the above-described technology, when each of the secondary coils is located at a position facing the primary coil, transmission efficiency is maximized. As the tire rotates, the position where the primary coil and each of the secondary coils face each other changes, so that transmission power fluctuates. Therefore, at some relative position of the tire with respect to the primary coil in the rotational direction while the vehicle stops or travels at low speed, transmission power may be low and sufficient power may be not able to be fed to the transmission device and the sensor.

### SUMMARY

The present technology provides a tire capable of enhancing transmission efficiency while suppressing a fluctuation in transmission power when feeding power to an electronic device provided in the tire, and a power feed system applied to the tire.

The present disclosure includes the following aspects.

### Aspect 1

A tire including a power reception coil configured to receive an AC magnetic field from outside the tire to generate power,
the tire including
a power reception coil provided on a side inner surface of a side portion between a tread portion and a bead portion, the side inner surface facing a tire cavity region of the tire, the power reception coil being configured to generate AC (alternating current) power by receiving an AC magnetic field transmitted through the side portion,
the power reception coil being a coil having a circular shape, the coil extending to make one round in a tire circumferential direction along the side inner surface, and
a ratio Ts/Tmin being from 1.0 to 5.5, where Ts (mm) is a thickness of the side portion at a position of the side inner surface where the power reception coil is provided, and Tmin (mm) is a minimum thickness among thicknesses of the side portion extending in a tire radial direction.

### Aspect 2

The tire according to aspect [1], wherein
the power reception coil is referred to as a first power reception coil, and the tire further includes a second power reception coil provided on the side inner surface, the second power reception coil being configured to generate an AC magnetic field by receiving the AC magnetic field transmitted through the side portion, and
the second power reception coil is a coil having a circular shape, the coil extending to make one round in the tire circumferential direction along the side inner surface concentrically with the first power reception coil.

### Aspect 3

The tire according to aspect [2], wherein
the first power reception coil and the second power reception coil include an intermittent section, the intermittent section being formed such that both end portions of each of the first power reception coil and the second power reception coil extend to deviate from the tire circumferential direction and thus each of the first power reception coil and the second power reception coil is intermittent in the tire circumferential direction, and
an angle formed by the intermittent section of the first power reception coil and the intermittent section of the second power reception coil in the tire circumferential direction is 4 degrees or more.

### Aspect 4

The tire according to aspect [2] or [3], wherein
regarding a height along the tire radial direction relative to an end of the bead portion on an inner side in the tire radial direction, at least one of the following relationships is satisfied:

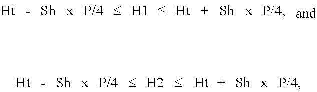

where
Sh (mm) is a cross-sectional height of the tire, Ht (mm) is a height of a position on the side inner surface where a thickness of the side portion is Tmin, H1 (mm) is a height of a position on the side inner surface where the first power reception coil is provided, H2 (mm) is a height of a position on the side inner surface where the second power reception coil is provided, and P×100% is an aspect ratio of the tire.

### Aspect 5

A power feed system wirelessly transmitting power from a power transmission unit to a power reception unit provided in a tire to feed power to an electronic device connected to the power reception unit,
the power transmission unit including a power transmission coil provided at a base portion non-rotational with respect to the tire, the power transmission coil being configured to generate an AC magnetic field,
the power reception unit including a power reception coil provided on a side inner surface of a side portion between a tread portion and a bead portion of the tire, the side inner surface facing a tire cavity region of the tire, the power reception coil being configured to generate AC power by receiving the AC magnetic field generated by the power transmission coil and transmitted through the side portion,
the electronic device being driven upon receipt of fed power converted from the AC power into DC (direct current) power in the power reception unit,
the power transmission coil being provided at the base portion and thus being disposed on a side opposite to a side of the power reception coil with respect to the side portion,
the power reception coil being a coil having a circular shape, the coil extending to make one round in a tire circumferential direction along the side inner surface, and
a ratio Ts/Tmin being from 1.0 to 5.5, where Ts (mm) is a thickness of the side portion at a position, in a tire radial direction, of the side inner surface where the power reception coil is provided, and Tmin (mm) is a minimum thickness among thicknesses of the side portion extending in a tire radial direction.

### Aspect 6

The power feed system according to aspect [5], wherein,
the power transmission coil includes a power transmission region having a planar shape and disposed to face the side portion,
the power transmission coil includes a curved portion having an arc shape extending with a predetermined curvature in a plane of the power transmission region, and
as viewed in a tire width direction, the curved portion forms a partial section of a circle in a circumferential direction, the circle being concentric with the circular shape of the power reception coil.

### Aspect 7

The power feed system according to aspect [6], wherein
the power reception coil includes an intermittent section formed such that both end portions of the power reception coil extend to deviate from the tire circumferential direction and thus the power reception coil is intermittent in the tire circumferential direction, and
a ratio d/L is 1/3 or less, the ratio d/L being a ratio of a spacing d (mm) between both end portions of the intermittent section in the tire circumferential direction with respect to a length L (mm) of the curved portion along the tire circumferential direction.

### Aspect 8

The power feed system according to aspect [6] or [7], wherein
the power reception coil is referred to as a first power reception coil, and the power reception unit further includes a second power reception coil provided on the side inner surface, the second power reception coil being configured to generate an AC magnetic field by receiving the AC magnetic field transmitted through the side portion, and
the second power reception coil is a coil having a circular shape, the coil extending to make one round in the tire circumferential direction along the side inner surface concentrically with the first power reception coil.

### Aspect 9

The power feed system according to aspect [8] or [9], wherein a ratio R/G is from 0.1 to 1.2, the ratio R/G being a ratio of a spacing R (mm) between the first power reception coil and the second power reception coil in the tire radial direction with respect to an average value G (mm) of a distance between the power transmission region and the first power reception coil and a distance between the power transmission region and the second power reception coil.

### Aspect 10

The power feed system according to any one of aspects [8] to [10], wherein, in a cross-section passing through the curved portion along the tire radial direction, a first radial region and a second radial region are not separated in the tire radial direction, the first radial region being a region where the curved portion is located, the second radial region being a region including both ends at positions of the first power reception coil and the second power reception coil in the tire radial direction, the first power reception coil and the second power reception coil being located on a side opposite to a side of the curved portion with respect to the side portion.

### Aspect 11

The power feed system according to any one of aspects [8] to [10], wherein the power transmission unit further includes a magnetic body disposed on a side opposite to a side of the side portion with respect to the power transmission coil, the magnetic body having a relative magnetic permeability of 30 to 300 at a frequency of the AC magnetic field generated by the power transmission coil.

### Aspect 12

The power feed system according to aspect [11], wherein
the magnetic body is disposed on the side opposite to the side of the side portion with respect to the power transmission coil, the magnetic body being disposed at a spacing h (mm) from the power transmission coil, and
a ratio h/G is from 0.01 to 0.5, the ratio h/G being a ratio of the spacing h with respect to an average value G (mm) of a distance between the power transmission region and the first power reception coil and a distance between the power transmission region and the second power reception coil.

### Aspect 13

The power feed system according to any one of aspects [8] to [12], wherein at least one of a ratio Ts1/G1 or a ratio Ts2/G2 is from 0.1 to 0.7, the ratio Ts1/G1 being a ratio of a thickness Ts1 (mm) of the side portion at a position of the side inner surface where the first power reception coil is provided with respect to a distance G1 (mm) between the power transmission coil and the first power reception coil in the tire width direction, the ratio Ts2/G2 being a ratio of a thickness Ts2 (mm) of the side portion at a position of the side inner surface where the second power reception coil is provided with respect to a distance G2 (mm) between the power transmission region and the second power reception coil in the tire width direction.

### Aspect 14

The power feed system according to any one of aspects [5] to [13], wherein
each of the power transmission coil and the power reception coil includes one conductive wire made of monofilament, and
a diameter of a conductor of the conductive wire of the power transmission coil is larger than a diameter of a conductor of the conductive wire of the power reception coil.

### Aspect 15

The power feed system according to any one of aspects [5] to [14], wherein, as viewed in the tire width direction, the power transmission coil is located within an angular range of 45 degrees on an individual side of both sides of a line in the tire circumferential direction, the line extending vertically upward from a center axis of rotation of the tire.

According to the tire and the power feed system described above, it is possible to enhance transmission efficiency while suppressing a power fluctuation when feeding power to an electronic device provided in a tire.

### BRIEF DESCRIPTION OF DRAWINGS

FIG. 1 is a diagram illustrating examples of a tire cross-section and a power feed system of an embodiment.

FIG. 2 is a diagram illustrating, in a plan view, a power reception coil.

FIG. 3 is a cross-sectional view for describing placement of a power reception coil.

FIG. 4 is a diagram illustrating, in a plan view, a power transmission coil.

FIG. 5A is a diagram illustrating an overlap between a power transmission coil and a power reception coil as viewed in a tire width direction, and FIG. 5B is a partially enlarged view of FIG. 5A.

FIG. 6A is a diagram illustrating an overlap between a power transmission coil and an intermittent section of a power reception coil as viewed in a tire width direction, and FIG. 6B is a partially enlarged view of FIG. 6A.

FIG. 7 is a diagram for describing placement of a power transmission coil and power reception coils.

FIG. 8 is a diagram for describing placement of two power reception coils.

FIGS. 9A to 9D are cross-sectional views for describing a positional relationship between a power transmission coil and power reception coils along a tire radial direction.

FIG. 10 is a diagram for describing a magnetic body.

FIG. 11 is a diagram for describing placement of a magnetic body, a power transmission coil, and power reception coils.

FIG. 12 is a diagram illustrating an example of a cross-section of a coil.

FIG. 13 is a cross-sectional view for describing a relationship between distances between a power transmission coil and power reception coils and thicknesses of a side portion.

FIG. 14 is a cross-sectional view for describing a relationship between height positions of power reception coils and an aspect ratio of a tire.

FIG. 15 is a diagram for describing an angular range around a center axis of rotation of a tire in which a power transmission coil is disposed.

### DETAILED DESCRIPTION

A tire and a power feed system that feeds power to an electronic device provided in the tire according to an embodiment will be described below with reference to the drawings. The tire of the embodiment of the present technology is preferably a pneumatic tire, and a pneumatic tire is used as an example in the following description. Gas with which a cavity region surrounded by the pneumatic tire and a rim is inflated is not limited to air and may be an inert gas such as nitrogen or another gas.

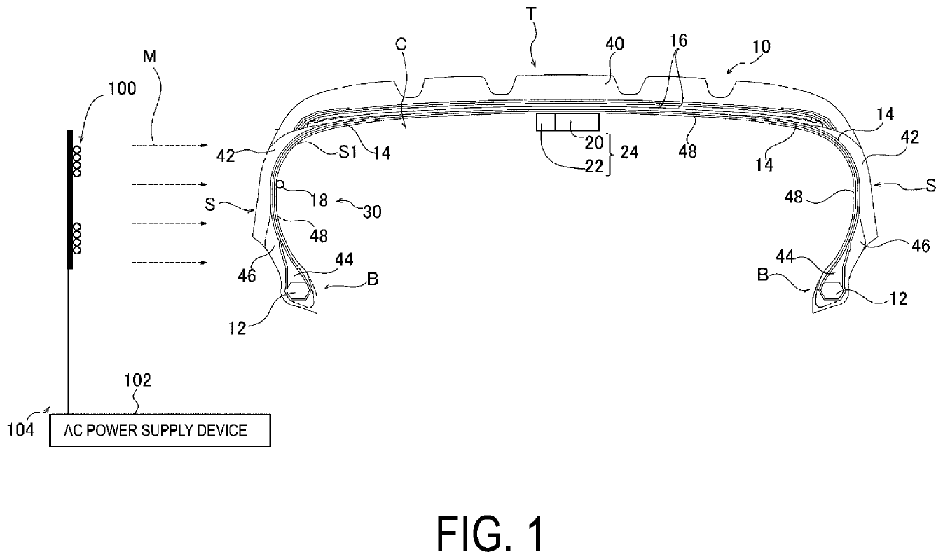

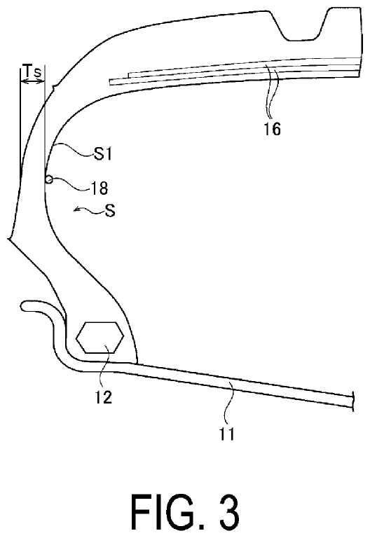

FIG. 1 is a diagram illustrating an example of a cross-section of the pneumatic tire and the power feed system including the pneumatic tire. A pneumatic tire 10 (hereinafter simply referred to as “tire”) illustrated in FIG. 1 includes, as a backbone portion, a pair of bead cores 12, a carcass ply layer 14, and a belt layer 16. The tire 10 is mounted on a wheel 11 (see FIG. 3). In FIG. 3, a portion (a rim bottom surface, a rim flange) of the wheel 11 is illustrated.

Each of the bead cores 12 is an annular member formed of a bead wire made from steel and wound in multiple stages in the tire circumferential direction. A bead portion B is formed of the bead core 12, and rim cushion rubber 46, the carcass ply layer 14, and innerliner rubber 48 disposed around the bead core 12. The bead portion B is provided on each of both sides in the tire width direction.

The carcass ply layer 14 is a member formed of an organic fiber cord and wound about each of the bead cores 12 and folded back to have a toroidal shape. In the carcass ply layer 14, the organic fiber cord is provided extending in the tire radial direction or the tire width direction. The tire 10 illustrated in FIG. 1 is formed of the single carcass ply layer 14. However, a plurality of the carcass ply layers may have a toroidal shape.

The belt layer 16 is provided on an outer side of the carcass ply layer 14 in the tire radial direction and is formed of a belt cord made from steel. The belt layer 16 is formed of two multi-layered belts, and the steel cords are inclined in different directions from each other with respect to the tire circumferential direction to form a crossing layer.

Tread rubber 40, side rubber 42, bead filler rubber 44, the rim cushion rubber 46, and the innerliner rubber 48 are provided around the backbone portion. The tread rubber 40, and the belt layer 16, the carcass ply layer 14, and the innerliner rubber 48 layered on the tread rubber 40 form a tread portion T. The side rubber 42, the bead filler rubber 44, the rim cushion rubber 46, the carcass ply layer 14, and the innerliner rubber 48 are curved on the outer side of the bead core 12 in the tire radial direction in a shape protruding toward the outer side in the tire width direction. In the example illustrated in FIG. 1, a side portion S is a portion between the tread portion T and the bead portion B, and is formed of the side rubber 42, the rim cushion rubber 46, the carcass ply layer 14, and the innerliner rubber 48. The side portion S is provided between the tread portion T and the bead portion B and is provided on each of both sides in the tire width direction. Note that the configuration of the rubber of the side portion S is not limited to the above-described configuration. In addition to the side rubber 42, the rim cushion rubber 46, and the innerliner rubber 48, the side portion S may further include rubber such as a supplementary filler, a run-flat liner, and a bead filler. The supplementary filler is rubber that reinforces a portion of the side portion S on the side of the bead portion B. For example, the supplementary filler is disposed so as to be interposed between the carcass ply layer and the rim cushion rubber or the side rubber, and has a rubber hardness higher than the side rubber. The run-flat liner is rubber that reinforces a side portion of the run-flat tire. For example, the run-flat liner is disposed so as to be interposed between the carcass ply layer and the innerliner rubber, and has a rubber hardness equal to or higher than the side rubber.

The tire 10 further includes a power reception unit 30 and an electronic device 24.

The power reception unit 30 receives power fed from outside the tire through wireless power transmission. The power reception unit 30 includes a power reception coil 18.

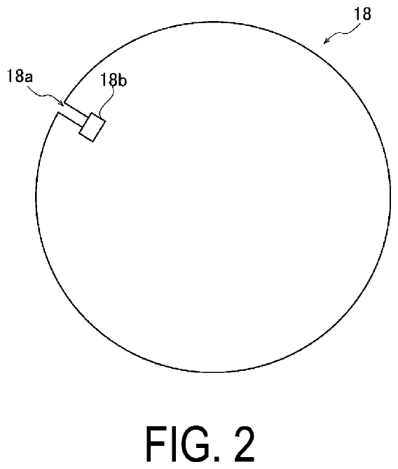

The power reception coil 18 is provided on a side inner surface S1 facing a cavity region C of the tire 10. The power reception coil 18 receives an AC magnetic field transmitted through the side rubber 42, the carcass ply layer 14, and the innerliner rubber 48 of the side portion S to generate AC power according to the AC magnetic field. The AC magnetic field received by the power reception coil 18 may be also transmitted through the rim cushion rubber 46 depending on the position of the power reception coil 18. The AC magnetic field received by the power reception coil 18 may be also transmitted through other rubber such as the supplementary filler, the run-flat liner, and the bead filler depending on the configuration of the rubber of the side portion S. The tire cavity region C is a region that is surrounded by a tire inner circumferential surface and the rim bottom surface of the wheel 11 on which the tire is mounted (partially illustrated in FIG. 3 and the subsequent diagrams), and that is inflated with air to a predetermined internal pressure. The power reception coil 18 is a circular coil extending to make one round in the tire circumferential direction along the side inner surface S1. The power reception coil 18 in the example illustrated in FIG. 2 is a circular coil of one turn. FIG. 2 is a diagram illustrating, in a plan view, the power reception coil 18. Among the pair of side portions S, the power reception coil 18 is provided at the side portion S disposed to face the side (vehicle inner side) of the vehicle on which the tire 10 is mounted via the wheel 11.

The power reception unit 30 further includes a rectifier circuit and a stabilization circuit (not illustrated), and AC power generated by the power reception coil 18 is converted into DC power and becomes power having a predetermined voltage.

The electronic device 24 includes a sensor unit 20 and a communication device 22. The sensor unit 20 includes a sensor element (not illustrated) that is fed with the DC power converted from the AC power generated by the power reception coil 18 and that is driven by the power. The sensor element is not particularly limited, but is, for example, an acceleration sensor that measures deformation behavior of the tread portion T of the tire 10 during rolling. The sensor unit 20 may further include an arithmetic processing circuit (not illustrated) that processes, through arithmetic processing, data of a measurement result measured by the sensor element.

The communication device 22 is a portion that transmits, in a wireless or wired manner, all of data measured by the sensor unit 20 or processed information to a communication device (not illustrated) outside the tire, and also receives the DC power converted from the generated AC power to be driven by the power.

A power line (not illustrated) extending from the power reception unit 30 is connected to the sensor unit 20 and the communication device 22. The DC power from the power reception unit 30 is used for driving power of the sensor unit 20 and driving power of the communication device 22 (power for signal processing, transmission, and the like).

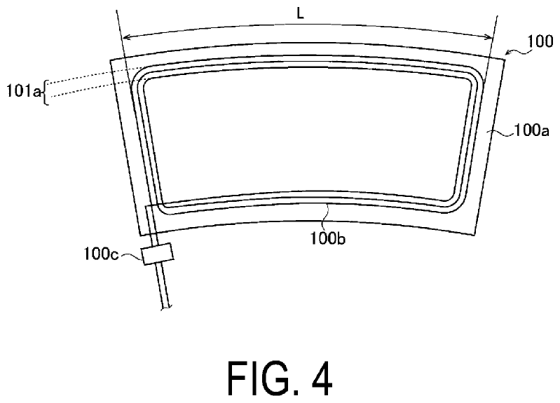

The AC magnetic field received by the power reception coil 18 is generated by a power transmission unit 104 including, for example, an AC power supply device 102 and a power transmission coil 100 illustrated in FIG. 1. The AC power supply device 102 may be fed with power from a battery mounted on the vehicle body or may be fed with power directly or via a rectifier/regulator from regenerative power or the like generated by an alternator or a drive motor without via the battery. The power transmission coil 100 is provided at a base portion non-rotational with respect to rotation of the tire 10, for example, a non-rotational portion (for example, knuckle) of a suspension. A capacitor constituting a resonance circuit together with the power transmission coil 100 is connected to the power transmission coil 100, and is disposed in a rectangular region indicated by the reference numeral 100c in FIG. 4. The power transmission unit 104 generates AC power using an inverter provided in the AC power supply device 102, and generates an AC magnetic field M at the power transmission coil 100.

According to an embodiment, power from the power transmission unit 104 to the power reception unit 30 is transmitted by a magnetic field resonance method. In the magnetic field resonance method, the resonant frequency in a circuit of the power transmission unit 104 is made to match the resonant frequency in a circuit of the power reception unit 30, and thus the AC magnetic field generated at the power transmission coil 100 causes the power reception coil 18 to resonate. In other words, an AC current flows through the power reception coil 18 due to the resonance, and the AC current is rectified, and thus DC power can be obtained.

In the magnetic field resonance method, the transmission efficiency of power is higher than in a magnetic induction method in the related art, and a transmission distance is also longer. From this point, the resonant frequency of the power transmission unit 104 and the resonant frequency of the power reception unit 30 preferably match each other. The resonant frequencies are adjusted, for example, by adjusting inductances of coils or capacitances in resonance circuits of the power transmission unit 104 and the power reception unit 30. On the other hand, since transmission efficiency is enhanced by making a transmission distance as short as possible, the power reception coil 18 is provided at the side portion S as described above. Accordingly, the transmission distance to the power transmission coil 100 provided at the non-rotational portion of the suspension is shortened, and high transmission efficiency is obtained.

In addition, when the magnetic field resonance method is used, the presence of a conductive material such as a metal in the vicinity of the power reception coil 18 causes a loss due to an eddy current and decreases transmission efficiency. Therefore, the power reception coil 18 is preferably provided at the side portion S away from the conductive material (for example, the belt cord of the belt layer 16 and the bead wire of the bead core 12).

As described above, the power reception coil 18 is a circular coil extending to make one round in the tire circumferential direction along the side inner surface S1. Therefore, the position and the length of a peripheral portion of the power reception coil 18 facing the power transmission coil 100 are not substantially changed by rotation of the tire 10, and a fluctuation in transmission power is suppressed. Therefore, even when the vehicle stops or travels at low speed, the magnitude of power fed to the electronic device is maintained constant. In this manner, the power reception coil 18 can feed power at any time regardless of traveling or stopping of the vehicle or the vehicle speed. The power reception coil 18 preferably has a circular shape with a constant curvature. In addition, the power reception coil 18 is preferably disposed to make one round along a concentric circle of the side portion S around the center axis of rotation of the tire 10. Note that “tire circumferential direction” refers to the direction around the center axis of rotation of the tire. The position of the concentric circle of the side portion S is defined in a state where the tire 10 is not in contact with the ground. In this manner, since the power reception coil 18 is a loop-shaped coil forming a closed region including the center axis of rotation of the tire on the inner circumferential side, a region occupied by the power reception coil 18 in the side inner surface S1 in the tire radial direction is small. Therefore, even when the power reception coil 18 is provided at a thin portion of the side portion S where the amount of vertical deflection accompanying rolling of the tire 10 is large, the power reception coil 18 is unlikely to be separated or fall off from the side inner surface S1. On the other hand, when a plurality of the coils are provided on the side inner surface so as to be adjacent to each other in the tire circumferential direction, a region occupied by the coils in the side inner surface in the tire radial direction is large, and the amount of deformation of the coils that deform following the vertical deflection of the side portion is large, so that the coils are likely to be separated or fall off from the side inner surface.

In the tire 10 of the present embodiment, a ratio Ts/Tmin is from 1.0 to 5.5, where Ts (mm) is the thickness of the side portion S in the tire axial direction at a position of the side inner surface S1 where the power reception coil 18 is provided (see FIG. 3), and Tmin (mm) is the minimum thickness among thicknesses, in the tire axial direction, of the side portion S extending in the tire radial direction. The tire axial direction refers to the direction parallel with the center axis of rotation of the tire. The tire axial direction is parallel with the tire width direction. FIG. 3 is a cross-sectional view for describing placement of the power reception coil 18. By providing the power reception coil 18 at the thin portion of the side portion S in this manner, attenuation of an AC magnetic field passing through the side portion S can be minimized, and transmission efficiency can be enhanced. In this manner, according to the present embodiment, it is possible to enhance transmission efficiency while suppressing a fluctuation in transmission power when feeding power to the electronic device. The ratio Ts/Tmin is more preferably 4.0 or less. The thickness Ts of the side portion S in the tire axial direction is a total thickness of the side rubber 42, the carcass ply layer 14, and the innerliner rubber 48 when the power reception coil 18 is provided at a position illustrated in FIG. 1.

In addition, the rubber of the tire generates heat due to traveling. In addition, the power reception coil may also generate heat due to wireless power feeding. Thus, when the power reception coil is provided at a position of the side portion where the rubber generates a large amount of heat, the heat generated in the rubber is prevented from being dissipated, which may cause a tire failure. In the tire 10 of the present embodiment, the power reception coil 18 is provided at the thin portion of the side portion S as described above, and thus generated heat is more likely to be dissipated than at the thick portion of the side portion S.

Furthermore, the thin portion of the side portion S has a large amount of vertical deflection accompanying rolling of the tire 10 as described above, and, in some form of the power reception coil, the power reception coil may be separated or fall off from the side inner surface S1. However, since the power reception coil 18 is a circular coil, the amount of deformation following deflection of the side portion is small compared to a related-art power reception coil including a power reception region extending in the tire radial direction, and the durability of the power reception coil 18 is improved.

Note that the range of the ratio Ts/Tmin is preferably from 1.0 to 5.5 and more preferably from 1.0 to 4.2 when the side portion S includes a portion (rim protection portion) protruding toward the outer side in the tire width direction from an outside position of the rim in the tire radial direction, the portion having a maximum thickness 1.5 times or more, preferably 2 times or more, the minimum thickness Tmin of the side portion S in the tire axial direction. The side portion S illustrated in FIG. 1 includes a rim protection portion. The range of the ratio Ts/Tmin when the side portion S does not include the rim protection portion is preferably from 1.0 to 3.3 and more preferably from 1.0 to 3.0. When the side portion S includes a run-flat liner, the range of the ratio Ts/Tmin is preferably from 1.0 to 1.8 and more preferably from 1.0 to 1.5 regardless of the presence or absence of the rim protection portion. Note that both ends of the side portion in the tire radial direction are, for example, both ends of a region of side rubber in the tire radial direction, the side rubber being exposed to the tire outer surface on the side opposite to the tire inner surface of the side portion.

In addition, since the power reception coil 18 is provided on the side inner surface S1 of the side portion S, generated heat accompanying AC power generation is dissipated more easily than in a case where the power reception coil 18 is embedded in the side portion S at least partially, which is thus preferable.

Note that the power reception coil 18 can be fixed to the side inner surface S1 by, for example, being bonded to the tire inner circumferential surface with an adhesive or the like or by a known fixing method.

In the power feed system of an embodiment, power is wirelessly transmitted from the power transmission unit 104 to the power reception unit 30 provided in the tire 10 mounted on the wheel 11, and the power is fed to the electronic device 24. The power feed system includes the power transmission unit 104 and the power reception unit 30.

The power transmission unit 104 includes the power transmission coil 100 provided at the portion non-rotational with respect to the tire 10 and generating an AC magnetic field. The power transmission coil 100 is disposed on the side opposite to the side of the power reception coil 18 with respect to the side portion S, specifically, on the outer side with respect to the side portion S in the tire width direction.

The power reception unit 30 is provided in the tire 10.

Specifically, as described above, the power reception unit 30 includes the power reception coil 18, and the electronic device 24 includes the sensor unit 20 and the communication device 22. The power reception coil 18 is provided on the side inner surface S1 of the side portion S facing the tire cavity region C of the tire 10. The power reception coil 18 receives an AC magnetic field generated by the power transmission coil 100 and transmitted through the side portion S to generate AC power.

In this power feed system, the power reception coil 18 is a circular coil extending to make one round in the tire circumferential direction along the side inner surface S1, and the ratio Ts/Tmin is from 1.0 to 5.5, where Ts (mm) is the thickness of the side portion S at a position, in the tire radial direction, of the side inner surface S1 where the power reception coil 18 is provided, and Tmin (mm) is the minimum thickness among thicknesses of the side portion S extending in the tire radial direction. Thus, it is possible to suppress a fluctuation in transmission power when feeding power to the electronic device and enhance transmission efficiency.

The power transmission coil 100 is preferably provided at a position opposing the side portion S of the tire 10 in an unsprung region of the suspension of the vehicle on which the tire 10 is mounted. The power transmission coil 100 is disposed in this manner, and thus the power reception coil 18 and the power transmission coil 100 can be provided substantially opposing each other. Thus, the power reception coil 18 can efficiently receive an AC magnetic field.

For example, in the case of a strut suspension, the power transmission coil 100 is preferably provided in a damper case as the base portion, and in the case of a multi-link suspension, the power transmission coil 100 is preferably provided in a knuckle as the base portion.

Additionally, according to an embodiment, the single power transmission coil 100 is preferably provided with respect to the single tire 10. When a plurality of the power transmission coils 100 are provided adjacent to each other, cross coupling between the power transmission coils 100 adjacent to each other occurs, and thus power feed efficiency is likely to decrease.

As illustrated in FIG. 4, the power transmission coil 100 preferably includes a planar power transmission region disposed to face the side portion S. The power transmission region is a portion that generates an AC magnetic field. FIG. 4 is a diagram illustrating, in a plan view, the power transmission coil 100. The power transmission coil 100 is a coil obtained by installing an electric wire 100b in a helical shape (spiral shape) on a non-magnetic substrate 100a. The electric wire 100b may be formed of a conductive material printed on the non-magnetic substrate 100a, but a wire-shaped conductor may be disposed to form a coil shape. The electric wire 100b installed in this manner forms the power transmission region of the power transmission coil 100. Since the non-magnetic substrate 100a is provided at the base portion, the power transmission coil 100 can move integrally with the tire 10 during steering.

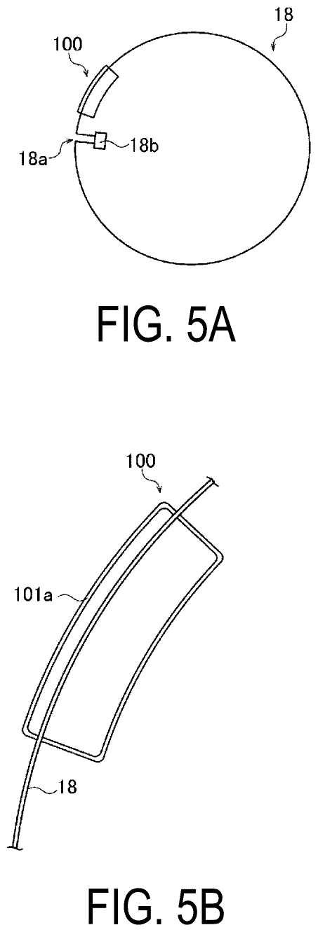

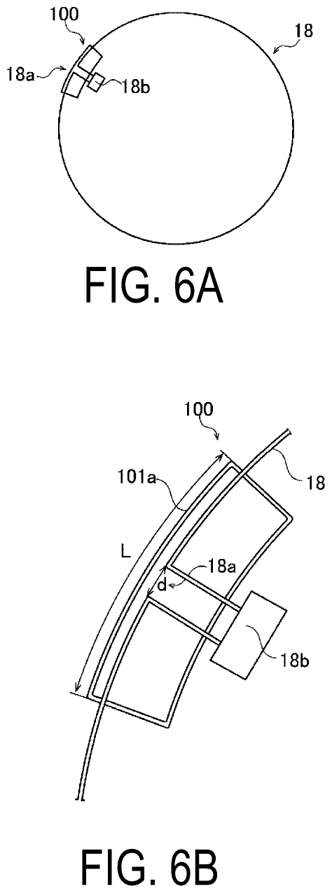

As illustrated in FIG. 4, the power transmission coil 100 preferably includes an arc-shaped curved portion 101a extending with a predetermined curvature in the plane of the power transmission region. In this case, as viewed in the tire width direction, the curved portion 101a preferably forms a partial section, in a circumferential direction, of a circle concentric with the circular shape of the power reception coil 18, as illustrated in FIG. 4. FIG. 5A is a diagram illustrating an overlap between the power transmission coil 100 and the power reception coil 18 as viewed in the tire width direction, and FIG. 5B is a partially enlarged view of FIG. 5A. The power transmission coil 100 illustrated in FIG. 5B and FIG. 6B described below is illustrated as a closed coil of one turn along the contour of the power transmission coil 100 for easy description. By providing the power transmission coil 100 with respect to the power reception coil 18 in this manner, an AC magnetic field from the power transmission coil 100 can be received by a longer peripheral portion of the power reception coil 18, which improves transmission efficiency. The curved portion 101a in the example illustrated in FIG. 4 is a portion of the power transmission region having an arc shape at the outermost portion in the tire radial direction. By using such a portion as the curved portion 101a, it is easy to ensure a long arc length of the curved portion 101a, and it is easy to ensure a long peripheral portion of the power reception coil 18 receiving an AC magnetic field from the power transmission coil 100.

As illustrated in FIGS. 2, 5 and 6, the power reception coil 18 includes an intermittent section 18a formed such that both end portions of the power reception coil 18 in the circumferential direction extend to deviate from the tire circumferential direction and thus the power reception coil 18 is intermittent in the tire circumferential direction. FIG. 6A is a diagram illustrating an overlap between the power transmission coil 100 and the intermittent section 18a of the power reception coil 18 as viewed in the tire width direction, and FIG. 6B is a partially enlarged view of FIG. 6A. A capacitor constituting a resonance circuit together with the power reception coil 18 is connected to the power lines at both end portions of the power reception coil 18 forming the intermittent section 18a. In the example illustrated in FIGS. 5 and 6, the capacitor is disposed in a rectangular region indicated by the reference numeral 18b. A ratio d/L is preferably 1/3 or less, the ratio d/L being a ratio of a spacing d (mm) between both end portions of the power reception coil 18 in the tire circumferential direction at the intermittent section 18a with respect to a length L (mm) of the curved portion 101a of the power transmission coil 100 along the tire circumferential direction (see FIGS. 4 and 6B). Because the ratio d/L is 1/3 or less, power can be also stably transmitted when the tire 10 rotates and accordingly the intermittent section 18a passes through a region of the side inner surface S1 overlapping the power transmission region of the power transmission coil 100 as viewed in the tire width direction. In addition, when the tire 10 stops rolling, a region through which an AC magnetic field generated by the power transmission coil 100 passes becomes small in the region of the intermittent section 18a, and power feeding can be maintained. The ratio d/L is preferably 1/4 or less. On the other hand, the two power lines forming the intermittent section 18a are preferably not in contact with each other to prevent a decrease in transmission efficiency due to the proximity effect, and the ratio d/L is preferably 1/20 or more. Note that the length L of the curved portion 101a is preferably from 50 to 180 mm in view of the balance between the magnitude of transmitted power and restriction of an installation space of the base portion to which the power transmission coil 100 is attached.

When the power reception coil 18 is referred to as a first power reception coil 18, the power reception unit 30 preferably further includes a second power reception coil 28. The second power reception coil 28 is provided on the side inner surface S1 and generates an AC magnetic field by receiving an AC magnetic field transmitted through the side portion S. The second power reception coil 28 is a circular coil extending to make one round in the tire circumferential direction along the side inner surface S1 concentrically with the first power reception coil 18. The resonant frequency in a circuit of the second power reception coil 28 matches the resonant frequency in the circuit of the power transmission unit 104, and an AC magnetic field generated by the power transmission coil 100 causes the second power reception coil 28 to resonate. As described above, the resonant frequency in the circuit of the first power reception coil 18 matches the resonant frequency in the circuit of the power transmission coil 100 and consequently also matches the resonant frequency in the circuit of the second power reception coil 28. Therefore, not only an AC magnetic field generated by the power transmission coil 100 but also an AC magnetic field generated by the second power reception coil 28 cause the first power reception coil 18 to resonate. According to the study of the present inventor, it was confirmed that by causing such a second power reception coil 28 to function as a relay coil in this manner, larger AC power was generated in the first power reception coil 18, and power feed efficiency was greatly improved. Unlike the first power reception coil 18, the second power reception coil 28 does not include a power line connected from the second power reception coil 28 to the communication device 22 and is independent of the communication device 22.

A ratio Ts2/Tmin is preferably from 1.0 to 5.5, where Ts2 (mm) is the thickness of the side portion S at a position of the side inner surface S1 where the second power reception coil 28 is provided. Accordingly, attenuation of an AC magnetic field passing through the side portion S, which is received by the second power reception coil 28, can be minimized, and the AC magnetic field can cause the first power reception coil 18 to strongly resonate. The preferable range of Ts2/Tmin for each rubber configuration of the side portion S is the same as the above-described preferable range of the ratio Ts/Tmin for each rubber configuration of the side portion S.

When the first power reception coil 18 is located in the vicinities of the steel cords of the belt layer 16 and the bead core 12, a conductive material located in the vicinity of a transmission path of an AC magnetic field causes a loss due to an eddy current, and transmission efficiency decreases, which is not preferable. In particular, in a tire having a lower aspect ratio, the spacing between the belt layer 16 and the bead core 12 is narrow, and the distance between the AC magnetic field and the conductive material is short. Therefore, the AC magnetic field may not reach the first power reception coil 18 with sufficient strength. In such a tire, by using the second power reception coil 28 together with the first power reception coil 18 and relaying or amplifying the AC magnetic field in the second power reception coil 28, it is possible to complement the AC magnetic field that causes the first power reception coil 18 to resonate, and it is possible to suppress a decrease in transmission efficiency. Therefore, of the first power reception coil 18 and the second power reception coil 28, a power reception coil closer to the steel cords of the belt layer 16 and the bead core 12 is preferably used as the first power reception coil 18, and a power reception coil farther therefrom is preferably used as the second power reception coil 28.

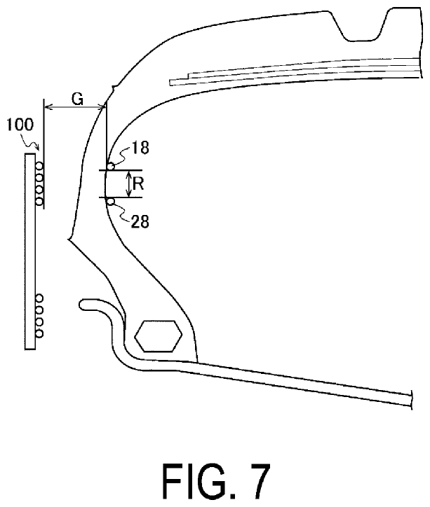

A ratio R/G is preferably from 0.1 to 1.2 and more preferably from 0.2 to 1.0, the ratio R/G being a ratio of a spacing R (mm) between the first power reception coil 18 and the second power reception coil 28 in the tire radial direction (see FIG. 7) with respect to an average value (average distance) G (mm) of the distances (shortest distances) between the power transmission region of the power transmission coil 100, and the first power reception coil 18 and the second power reception coil 28 (see FIG. 7). FIG. 7 is a diagram for describing placement of the power transmission coil 100 and the power reception coils 18, 28. For efficient power transmission, the distances between the power transmission coil 100 and the power reception coils 18, 28 are preferably short. However, when the distances between the power transmission coil 100 and the power reception coils 18, 28 are short, it is highly likely that the side portion S comes into contact with the power transmission coil 100 due to lateral deformation of the side portion S during tire cornering. On the other hand, in a tire having a low aspect ratio, the degree of lateral deformation of the side portion S during tire cornering is small, and it is less likely that the side portion S comes into contact with the power transmission coil 100. However, as described above, transmission efficiency is likely to decrease. Therefore, in a tire having a low aspect ratio, the spacing R between the first power reception coil 18 and the second power reception coil 28 in the radial direction is preferably small from the viewpoint of suppressing a decrease in transmission efficiency. When the ratio R/G is within the above range, it is possible to suppress a decrease in transmission efficiency while avoiding contact between the side portion S and the power transmission coil 100 in tires having various aspect ratios. The average distance G is preferably from 10 to 50 mm. When the average distance G is short, it is highly likely that the side portion S comes into contact with the power transmission coil 100. On the other hand, when the average distance G is long, transmission efficiency is likely to decrease due to a too long transmission distance.

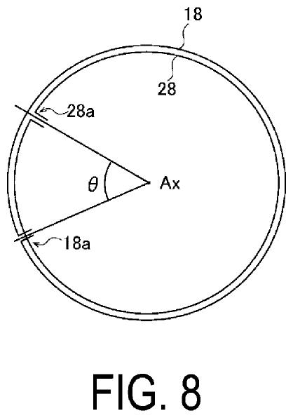

The second power reception coil 28 includes an intermittent section 28a formed such that both end portions of the second power reception coil 28 in the circumferential direction extend to deviate from the tire circumferential direction and thus the second power reception coil 28 is intermittent in the tire circumferential direction. A capacitor constituting a resonance circuit together with the second power reception coil 28 is connected to the power lines at both end portions of the second power reception coil 28 constituting the intermittent section 28a. As illustrated in FIG. 8, in the tire circumferential direction (around a center axis Ax of rotation of the tire), the angle formed by the intermittent section 18a of the first power reception coil 18 and the intermittent section 28a of the second power reception coil 28 is preferably 4 degrees or more. FIG. 8 is a cross-sectional view for describing placement of the two power reception coils 18, 28. The formed angle is an angle formed by respective center positions of the intermittent sections 18a, 28a in the tire circumferential direction. When the angle formed by the intermittent sections 18a, 28a is less than 4 degrees, the power lines constituting the intermittent sections 18a, 28a are too close to each other, and thus the resonance circuit of one power reception coil may be affected by the power lines of the other power reception coil to cause a loss. The above formed angle is preferably 5 degrees or more.

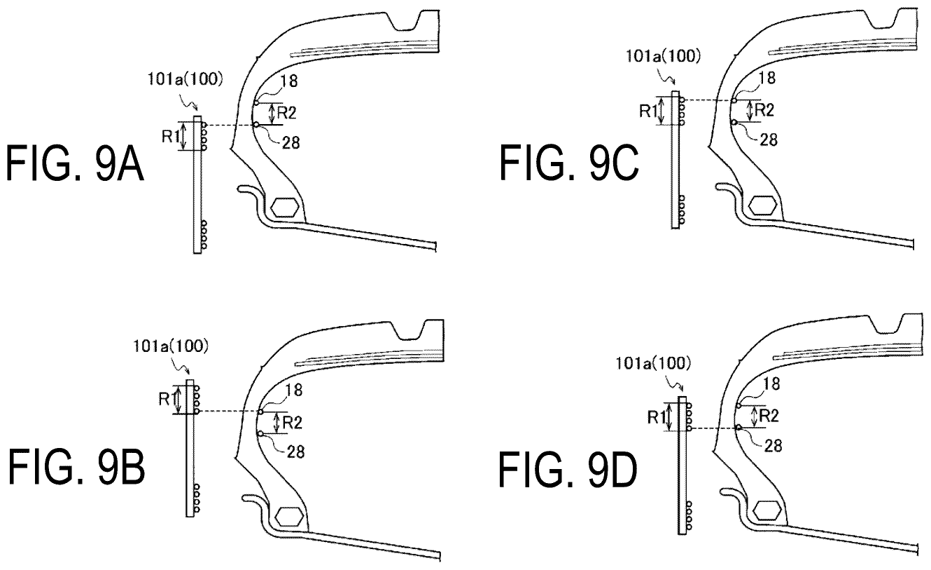

In the cross-section passing through the curved portion 101a of the power transmission coil 100 and the tire 10 along the tire radial direction, a first radial region R1 and a second radial region R2 are preferably not separated in the tire radial direction as illustrated in FIG. 9. The first radial region R1 is a region where the curved portion 101a is located. The second radial region R2 is a region including both ends at the positions of the first power reception coil 18 and the second power reception coil 28 in the tire radial direction, the first power reception coil 18 and the second power reception coil 28 being located on the side opposite to the curved portion 101a with respect to the side portion S (facing the curved portion 101a such that the side portion S is interposed therebetween). FIGS. 9A to 9D are cross-sectional views for describing the positional relationship between the power transmission coil 100 and the power reception coils 18, 28 along the tire radial direction. The first radial region R1 is a region, in the tire radial direction, that includes, at both ends in the tire radial direction, an outermost circumferential side portion and an innermost circumferential side portion of the electric wire 101b forming the curved portion 101a. When the power transmission coil 100 and the power reception coils 18, 28 are disposed such that the two radial regions R1, R2 are not separated from each other in the tire radial direction, an AC magnetic field generated by the power transmission coil 100 can be received with sufficient strength by the first power reception coil 18 and the second power reception coil 28, and the effect of improving transmission efficiency increases. Note that the two radial regions R1, R2 are determined in a state in which the tire 10 is mounted on the vehicle and inflated with air to a predetermined internal pressure (air pressure of a corresponding tire size is designated based on the vehicle and is 230 kPa unless otherwise specified). In the examples illustrated in FIGS. 9A and 9B, the first radial region R1 and the second radial region R2 are in contact with each other in the tire radial direction, and in the examples illustrated in FIGS. 9C and 9D, the first radial region R1 and the second radial region R2 overlap each other in the tire circumferential direction. In order that an AC magnetic field generated by the power transmission coil 100 is received with a sufficient strength by the power reception coils 18, 28 and that the effect of enhancing transmission efficiency increases, the first radial region R1 and the second radial region R2 preferably overlap each other in the tire circumferential direction as in the examples illustrated in FIGS. 9B and 9C.

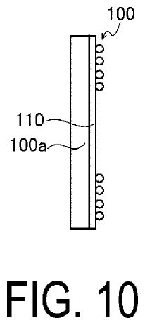

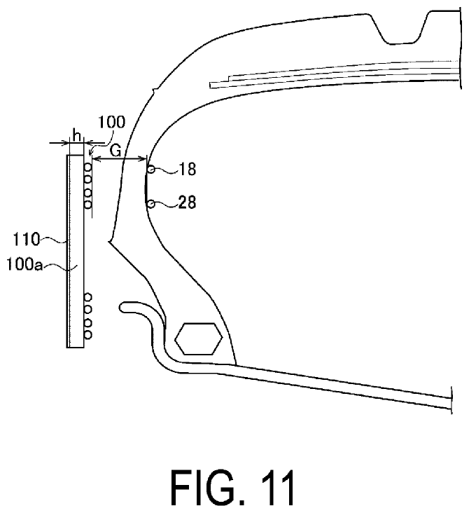

As illustrated in FIG. 10, the power transmission unit 104 preferably further includes a magnetic body 110 disposed on the side opposite to the side of the side portion S with respect to the power transmission coil 100. FIG. 10 is a diagram for describing the magnetic body 110. The relative permeability of the magnetic body 110 at the frequency of an AC magnetic field generated by the power transmission coil 100 is from 30 to 300. The magnetic body 110 in the example illustrated in FIG. 10 is a magnetic sheet having a surface parallel with the surface of the power transmission region of the power transmission coil 100. The magnetic body 110 in the example illustrated in FIG. 10 is in contact with the power transmission coil 100 and is layered on the surface of the non-magnetic substrate 100a on the side of the side portion S. The thickness of the magnetic sheet is preferably from 0.01 mm to 0.5 mm. The power transmission coil 100 is disposed, for example, in a vehicle wheel house accommodating the suspension, and a structural material or a component including a metal (conductor) such as aluminum or iron is disposed on the side opposite to the side where the power reception coils 18, 28 are provided with respect to the power transmission coil 100 (back surface side of the power transmission coil 100). For this reason, an AC magnetic field generated by the power transmission coil 100 generates an eddy current on the surface of the conductor, and a loss caused thereby may decrease transmission efficiency and cause the metal member to generate heat. Therefore, it is preferable to dispose a magnetic sheet to absorb or block a magnetic flux generated by the power transmission coil 100. More preferably, as illustrated in FIG. 11, the magnetic body 110 be disposed at a spacing h (mm) from the power transmission coil 100. By providing the spacing h, it is possible to inhibit the effect from decreasing due to magnetic saturation of the magnetic sheet. FIG. 11 is a diagram for describing placement of the magnetic body 110, the power transmission coil 100, and the power reception coils 18, 28. The non-magnetic substrate 100a in contact with the power transmission coil 100 is layered on the surface of the magnetic body 110 on the side of the side portion S in the example illustrated in FIG. 11. The distances between the power transmission coil 100 and the power reception coils 18, 28 are preferably short. Therefore, a ratio h/G is preferably 0.01 to 0.5, the ratio h/G being a ratio of the spacing h with respect to the average value (average distance) G (mm) of the distances (shortest distances) between the power transmission region of the power transmission coil 100 and the power reception coils 18, 28.

Each of the power reception coils 18, 28 and the power transmission coil 100 is preferably formed of one conductive wire made of monofilament. Such a coil is suitable for feeding power by the magnetic field resonance method using an electromagnetic wave having a frequency in the MHz band. The range of the frequency when the power is fed by the magnetic resonance method is preferably from 1 MHz to 1 GHz and more preferably from 2 to 20 MHz. In addition, each of the power reception coils 18, 28 formed of one conductive wire made of monofilament can prevent an increase in AC resistance due to the proximity effect as compared with a power reception coil formed of a power line made of a stranded wire and having the same cross-sectional area.

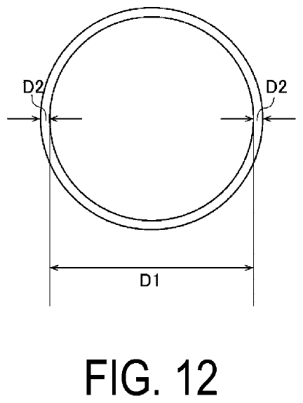

The diameter of the conductor of the conductive wire (monofilament) of the power transmission coil 100 is preferably larger than the diameter of the conductor of the conductive wire (monofilament) of each of the power reception coils 18, 28. As illustrated in FIG. 12, a diameter D1 of the conductor made of monofilament is a length obtained by subtracting a thickness D2 of a covering layer covering the conductor from the diameter of the monofilament. The conductor is made of, for example, copper and the coating layer is made of, for example, resin. A larger diameter of each of the power transmission coil 100 and the power reception coils 18, 28 is more advantageous from the viewpoint of generating a strong AC magnetic field and generating large AC power to enhance transmission efficiency. However, when each of the power reception coils 18, 28 is excessively large, a strain when the power reception coil is deformed following deformation of the side portion S is large, which may deteriorate durability. In addition, when the diameter of each of the power reception coils 18, 28 is excessively large, the power reception coil may be separated or fall off from the side inner surface S1 due to centrifugal force during rolling. For this reason, the diameter of the conductor of the conductive wire (monofilament) of the power transmission coil 100 is made larger than the diameter of the conductor of the conductive wire (monofilament) of each of the power reception coils 18, 28. Thus, it is possible to complement the effect of improving transmission efficiency suppressed by limiting the thicknesses of the power reception coils 18, 28, and it is further possible to ensure the durability of the power reception coils 18, 28. The diameter of the conductor of the conductive wire (monofilament) of each of the power reception coils 18, 28 is preferably from 0.5 to 1.0 mm. The diameter of the conductor of the conductive wire (monofilament) of the power transmission coil 100 is preferably from 0.8 to 1.5 mm. The number of turns of the power transmission coil 100 is preferably from 3 to 12.

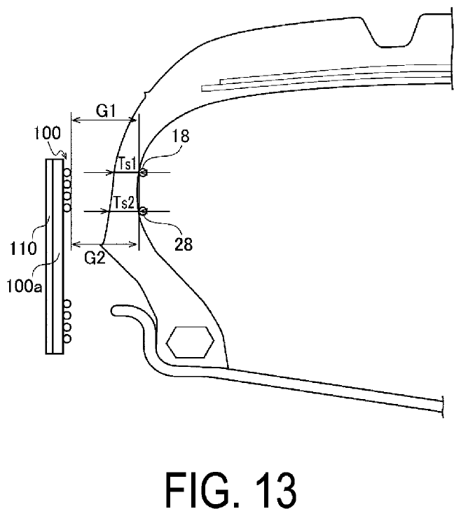

At least one of a ratio Ts1/G1 or a ratio TS2/G2 is preferably from 0.1 to 0.7 and more preferably both are from 0.1 to 0.7. The ratio Ts1/G1 is a ratio of a thickness Ts1 (mm) of the side portion S at a position of the side inner surface S1 where the first power reception coil 18 is provided (see FIG. 13) with respect to a distance (shortest distance) G1 (mm) between the power transmission coil 100 and the first power reception coil 18 in the tire width direction (see FIG. 13). The ratio Ts2/G2 is a ratio of a thickness Ts2 (mm) of the side portion S at a position of the side inner surface S1 where the second power reception coil 28 is provided (see FIG. 13) with respect to a distance (shortest distance) G2 (mm) between the power transmission coil 100 and the second power reception coil 28 in the tire width direction (see FIG. 13). FIG. 13 is a cross-sectional view for describing the relationship between the distances G1, G2 between the power transmission coil 100 and the power reception coils 18, 28 and the thicknesses Ts1, Ts2 of the side portion S. As described above, for efficient power transmission, the distances between the power transmission coil 100 and the power reception coils 18, 28 are preferably short. However, when the distances between the power transmission coil 100 and the power reception coils 18, 28 are excessively short, the degree of lateral deformation of the side portion S becomes excessively large as compared with the distances G1, G2, and a fluctuation width of transmitted power becomes large. In addition, when the distances between the power transmission coil 100 and the power reception coils 18, 28 are excessively short, it is highly likely that the side portion S comes into contact with the power transmission coil 100 due to lateral deformation of the side portion S during tire cornering. When at least one of the ratio Ts1/G1 or the ratio Ts2/G2 is limited to be within the above-described range, it is possible to efficiently transmit power while suppressing a fluctuation in transmission efficiency and avoiding contact between the side portion S and the power transmission coil 100. Each of the ratio Ts1/G1 and the ratio Ts2/G2 is more preferably from 0.2 to 0.6 and still more preferably from 0.15 to 0.55. The distances between the power transmission coil 100 and the power reception coils 18, 28 are adjusted by, for example, adjusting the thickness, along the tire width direction, of a pedestal for attaching the non-magnetic substrate 100a or the magnetic body 110 to the base portion.

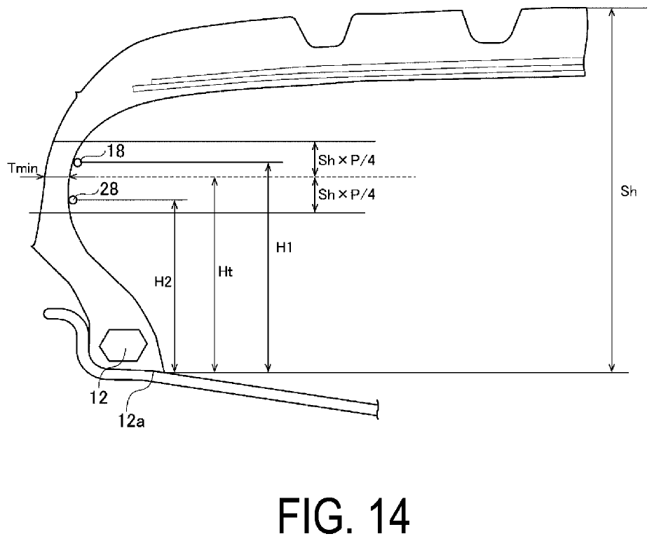

As illustrated in FIG. 14, regarding the height along the tire radial direction relative to an inside end of the bead portion B in the tire radial direction (direction toward or away from the center axis Ax of rotation of the tire 10), at least one of the following relationships is preferably satisfied and more preferably both of the following relationships are satisfied:

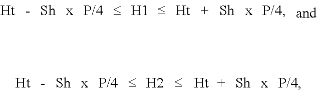

where
Sh (mm) is the cross-sectional height of the tire 10, Ht (mm) is the height of a position of the side inner surface S1 where the thickness of the side portion S is Tmin, H1 (mm) is the height of a position of the side inner surface S1 where the first power reception coil 18 is provided, H2 (mm) is the height of a position of the side inner surface S1 where the second power reception coil 28 is provided, and P×100% is the aspect ratio of the tire 10. FIG. 14 is a diagram for describing the relationship between the height positions of the power reception coils 18, 28 and the aspect ratio P. In the tire 10 having a low aspect ratio, the amount of vertical deflection of the side portion S is small, deformation of the power reception coils 18, 28 accompanying rolling of the tire 10 is suppressed, and the durability of the power reception coils 18, 28 is easily ensured. On the other hand, in the tire 10 having a low aspect ratio, transmission efficiency is likely to decrease due to the steel cords of the belt layer 16 and the bead core 12, and even when the ratio Ts1/Tmin or the ratio Ts2/Tmin at positions where the power reception coils 18, 28 are provided satisfies the above ranges, it may be difficult to suppress a decrease in transmission efficiency. Therefore, it is preferable that the height positions of the power reception coils 18, 28 be closer to the height position of the side portion S having the thickness Tmin, as the tire has a lower aspect ratio. When the height positions of the power reception coils 18, 28 are set so as to satisfy at least one of the above two relationships, the balance between the durability of the power reception coils 18, 28 and suppression of a decrease in transmission efficiency is particularly excellent. The aspect ratio P is preferably from 0.30 to 0.65.

The various dimensions described above in the present specification, such as R, R2, Sh, Ht, H1, and H2 are measured in an unloaded state in which the tire 10 is mounted on a regular rim and inflated to a regular internal pressure. “Regular rim” refers to a rim defined by a standard for each tire according to a system of standards that includes standards with which tires comply, and, for example, refers to “standard rim” defined by Japan Automobile Tyre Manufacturers Association (JATMA), “Design Rim” defined by The Tire and Rim Association, Inc. (TRA), or “Measuring Rim” defined by European Tire and Rim Technical Organization (ETRTO). When the tire 10 is an original equipment tire, a genuine wheel on which the tire 10 is mounted is used. In the system of standards, including standards with which tires comply, “regular internal pressure” is air pressure defined by each of the standards for each tire and refers to “maximum air pressure” defined by JATMA, the maximum value being listed in the table “TIRE LOAD LIMITS AT VARIOUS COLD INFLATION PRESSURES” defined by TRA, or “INFLATION PRESSURE” defined by ETRTO. However, “regular internal pressure” is 230 kPa in a case where the tire 10 is for a passenger vehicle. However, when the tire 10 is an original equipment tire, the air pressure is set to an air pressure designated based on a vehicle.

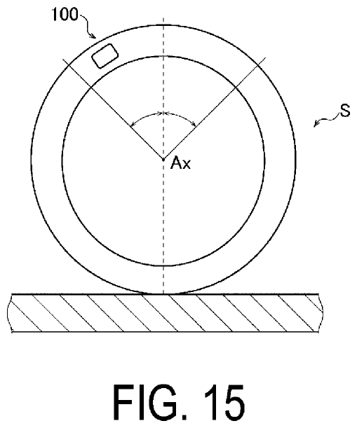

As viewed in the tire width direction (direction parallel with the center axis Ax of rotation of the tire 10), the power transmission coil 100 is preferably located within an angular range of 45 degrees (90 degrees in total) on each of both sides of an imaginary line in the tire circumferential direction, the imaginary line extending vertically upward from the center axis Ax of rotation of the tire 10, as illustrated in FIG. 15. FIG. 15 is a diagram for describing an angular range, in the tire circumferential direction (around the center axis Ax of rotation of the tire 10), where the power transmission coil 100 is disposed. When the power transmission coil 100 is located in the vicinity of the ground contact surface of the tire 10, the height positions of the power reception coils 18, 28 are likely to deviate from the height position of the power transmission coil 100 due to fluctuations in the height positions of the power reception coils 18, 28 accompanying vertical deflection deformation of the tire 10. Therefore, the power reception coils 18, 28 cannot sufficiently receive an AC magnetic field generated by the power transmission coil 100, which may decrease transmission efficiency. When the power transmission coil 100 is disposed within the above-described angular range, it is possible to decrease an influence on transmission power due to fluctuations in the height positions of the power reception coils 18, 28 accompanying vertical deflection deformation of the tire 10, and it is possible to suppress a decrease in transmission efficiency.

Although the tire and the power feed system of the embodiment of the present technology have been described in detail above, the tire and the power feed system of the embodiment of the present technology are not limited to the embodiment, and various improvements and changes may naturally be made without departing from the gist of the present technology.

1. A tire comprising a power reception coil configured to receive an AC magnetic field from outside the tire to generate power,
the tire comprising:
a power reception coil provided on a side inner surface of a side portion between a tread portion and a bead portion, the side inner surface facing a tire cavity region of the tire, the power reception coil being configured to generate AC power by receiving an AC magnetic field transmitted through the side portion,
the power reception coil being a coil having a circular shape, the coil extending to make one round in a tire circumferential direction along the side inner surface, and
a ratio Ts/Tmin being from 1.0 to 5.5, where Ts is a thickness of the side portion at a position of the side inner surface where the power reception coil is provided, and Tmin is a minimum thickness among thicknesses of the side portion extending in a tire radial direction.

2. The tire according to claim 1, wherein
the power reception coil is referred to as a first power reception coil, and the tire further comprises a second power reception coil provided on the side inner surface, the second power reception coil being configured to generate an AC magnetic field by receiving the AC magnetic field transmitted through the side portion, and
the second power reception coil is a coil having a circular shape, the coil extending to make one round in the tire circumferential direction along the side inner surface concentrically with the first power reception coil.

3. The tire according to claim 2, wherein
the first power reception coil and the second power reception coil comprise an intermittent section, the intermittent section being formed such that both end portions of each of the first power reception coil and the second power reception coil extend to deviate from the tire circumferential direction and thus each of the first power reception coil and the second power reception coil is intermittent in the tire circumferential direction, and
an angle formed by the intermittent section of the first power reception coil and the intermittent section of the second power reception coil in the tire circumferential direction is 4 degrees or more.

4. The tire according to claim 2, wherein
regarding a height along the tire radial direction relative to an end of the bead portion on an inner side in the tire radial direction, at least one of the following relationships is satisfied: 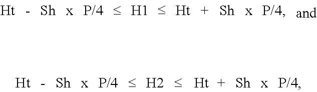
where
Sh is a cross-sectional height of the tire, Ht is a height of a position on the side inner surface where a thickness of the side portion is Tmin, H1 is a height of a position on the side inner surface where the first power reception coil is provided, H2 is a height of a position on the side inner surface where the second power reception coil is provided, and P×100% is an aspect ratio of the tire.

5. A power feed system wirelessly transmitting power from a power transmission unit to a power reception unit provided in a tire to feed power to an electronic device connected to the power reception unit,
the power transmission unit comprising a power transmission coil provided at a base portion non-rotational with respect to the tire, the power transmission coil being configured to generate an AC magnetic field,
the power reception unit comprising a power reception coil provided on a side inner surface of a side portion between a tread portion and a bead portion of the tire, the side inner surface facing a tire cavity region of the tire, the power reception coil being configured to generate AC power by receiving the AC magnetic field generated by the power transmission coil and transmitted through the side portion,
the electronic device being driven upon receipt of fed power converted from the AC power into DC power in the power reception unit,
the power transmission coil being provided at the base portion and thus being disposed on a side opposite to a side of the power reception coil with respect to the side portion,
the power reception coil being a coil having a circular shape, the coil extending to make one round in a tire circumferential direction along the side inner surface, and
a ratio Ts/Tmin being from 1.0 to 5.5, where Ts is a thickness of the side portion at a position, in a tire radial direction, of the side inner surface where the power reception coil is provided, and Tmin is a minimum thickness among thicknesses of the side portion extending in a tire radial direction.

6. The power feed system according to claim 5, wherein,
the power transmission coil comprises a power transmission region having a planar shape and disposed to face the side portion,
the power transmission coil comprises a curved portion having an arc shape extending with a predetermined curvature in a plane of the power transmission region, and
as viewed in a tire width direction, the curved portion forms a partial section of a circle in a circumferential direction, the circle being concentric with the circular shape of the power reception coil.

7. The power feed system according to claim 6, wherein
the power reception coil comprises an intermittent section formed such that both end portions of the power reception coil extend to deviate from the tire circumferential direction and thus the power reception coil is intermittent in the tire circumferential direction, and
a ratio d/L is 1/3 or less, the ratio d/L being a ratio of a spacing d between both end portions of the intermittent section in the tire circumferential direction with respect to a length L of the curved portion along the tire circumferential direction.

8. The power feed system according to claim 6, wherein
the power reception coil is referred to as a first power reception coil, and the power reception unit further comprises a second power reception coil provided on the side inner surface, the second power reception coil being configured to generate an AC magnetic field by receiving the AC magnetic field transmitted through the side portion, and
the second power reception coil is a coil having a circular shape, the coil extending to make one round in the tire circumferential direction along the side inner surface concentrically with the first power reception coil.

9. The power feed system according to claim 8, wherein a ratio R/G is from 0.1 to 1.2, the ratio R/G being a ratio of a spacing R between the first power reception coil and the second power reception coil in the tire radial direction with respect to an average value G of a distance between the power transmission region and the first power reception coil and a distance between the power transmission region and the second power reception coil.

10. The power feed system according to claim 8, wherein, in a cross section passing through the curved portion along the tire radial direction, a first radial region and a second radial region are not separated in the tire radial direction, the first radial region being a region where the curved portion is located, the second radial region being a region comprising both ends at positions of the first power reception coil and the second power reception coil in the tire radial direction, the first power reception coil and the second power reception coil being located on a side opposite to a side of the curved portion with respect to the side portion.

11. The power feed system according to claim 8, wherein the power transmission unit further comprises a magnetic body disposed on a side opposite to a side of the side portion with respect to the power transmission coil, the magnetic body having a relative magnetic permeability of 30 to 300 at a frequency of the AC magnetic field generated by the power transmission coil.

12. The power feed system according to claim 11, wherein
the magnetic body is disposed on the side opposite to the side of the side portion with respect to the power transmission coil, the magnetic body being disposed at a spacing h from the power transmission coil, and
a ratio h/G is from 0.01 to 0.5, the ratio h/G being a ratio of the spacing h with respect to an average value G of a distance between the power transmission region and the first power reception coil and a distance between the power transmission region and the second power reception coil.

13. The power feed system according to claim 8, wherein at least one of a ratio Ts1/G1 or a ratio Ts2/G2 is from 0.1 to 0.7, the ratio Ts1/G1 being a ratio of a thickness Ts1 of the side portion at a position of the side inner surface where the first power reception coil is provided with respect to a distance G1 between the power transmission coil and the first power reception coil in the tire width direction, the ratio Ts2/G2 being a ratio of a thickness Ts2 of the side portion at a position of the side inner surface where the second power reception coil is provided with respect to a distance G2 between the power transmission region and the second power reception coil in the tire width direction.

14. The power feed system according to claim 5, wherein
each of the power transmission coil and the power reception coil comprises one conductive wire made of monofilament, and
a diameter of a conductor of the conductive wire of the power transmission coil is larger than a diameter of a conductor of the conductive wire of the power reception coil.

15. The power feed system according to claim 5, wherein, as viewed in the tire width direction, the power transmission coil is located within an angular range of 45 degrees on an individual side of both sides of a line in the tire circumferential direction, the line extending vertically upward from a center axis of rotation of the tire.
